(19) United States
(12) Patent Application Publication
(10) Pub. No.: US 2025/0358781 A1
(43) Pub. Date: Nov. 20, 2025

(54) COMMUNICATION SYSTEM

(71) Applicant: TOYOTA JIDOSHA KABUSHIKI KAISHA, Toyota-shi (JP)

(72) Inventors: Toshiki SHINOHARA, Toyota-shi (JP); Masataka OKUDA, Toyota-shi (JP); Masatoshi KAKUTANI, Miyoshi-shi (JP); Kaoru YOSHIDA, Nisshin-shi (JP); Kanade KURIYAMA, Toyota-shi (JP)

(73) Assignee: TOYOTA JIDOSHA KABUSHIKI KAISHA, Toyota-shi (JP)

(21) Appl. No.: 19/014,919

(22) Filed: Jan. 9, 2025

(30) Foreign Application Priority Data
May 14, 2024 (JP) 2024-078898

(51) Int. Cl. H04W 64/00; H04W 4/021; H04W 4/40

(52) U.S. Cl. CPC H04W 64/006; H04W 4/021; H04W 4/40

(57) ABSTRACT

The communication system includes a plurality of vehicles including a first vehicle and a second vehicle, and a server capable of communicating with the plurality of vehicles. When the second vehicle is traveling in the following relationship with the first vehicle, the first vehicle transmits the absolute position information of the first vehicle including the coordinate values of the latitude and longitude at which the first vehicle is located and the inter-vehicle distance information of the second vehicle to the server. The second vehicle does not transmit the absolute position information of the second vehicle to the server. The server calculates the absolute position of the second vehicle based on the absolute position information of the first vehicle and the inter-vehicle distance information of the second vehicle.

### CROSS-REFERENCE TO RELATED APPLICATION

This application claims priority to Japanese Patent Application No. 2024-078898 filed on May 14, 2024, incorporated herein by reference in its entirety.

### BACKGROUND

### 1. Technical Field

The present disclosure relates to a communication system.

### 2. Description of Related Art

Japanese Unexamined Patent Application Publication No. 2016-212610 (JP 2016-212610 A) describes a communication system including a first vehicle, a second vehicle, and a server. In the communication system, the first vehicle transmits position information of the first vehicle and position information of the second vehicle to the server. The position information includes information on latitude and longitude.

### SUMMARY

In the communication system described in JP 2016-212610 A, the server receives information on latitude and longitude of the first vehicle and information on latitude and longitude of the second vehicle. Therefore, there is a possibility that the amount of information received by the server becomes excessively large.

In order to address the above issue, an aspect of the present disclosure provides
a communication system including: a plurality of vehicles including a first vehicle and a second vehicle; and
a server capable of communicating with the vehicles.
   In the communications system,
when the second vehicle is traveling in a following relationship with the first vehicle, the first vehicle acquires absolute position information of the first vehicle including coordinate values of latitude and longitude at which the first vehicle is located,
acquires inter-vehicle distance information of the second vehicle indicating an inter-vehicle distance that is a distance between the first vehicle and the second vehicle, and
transmits the absolute position information of the first vehicle and the inter-vehicle distance information of the second vehicle to the server,
the second vehicle does not transmit absolute position information of the second vehicle including coordinate values of latitude and longitude at which the second vehicle is located to the server, and
the server calculates the coordinate values of the latitude and the longitude at which the second vehicle is located, based on the absolute position information of the first vehicle and the inter-vehicle distance information of the second vehicle.

With the above communication system, it is possible to suppress the amount of information received by the server becoming excessively large.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a communication system;

FIG. 2 is a flowchart illustrating a process of determining a group by the server;

FIG. 3 is a flowchart illustrating a process in which a server makes a request to each vehicle;

FIG. 4 is a flowchart illustrating a process of transmission control performed by a subsequent vehicle;

FIG. 5 is a flow chart showing a process of transmitting control performed by the first vehicle; and

FIG. 6 is an explanatory diagram of a situation in which information is transmitted from a leading vehicle to a server.

### DETAILED DESCRIPTION OF EMBODIMENTS

Hereinafter, an embodiment of a communication system will be described with reference to the drawings.

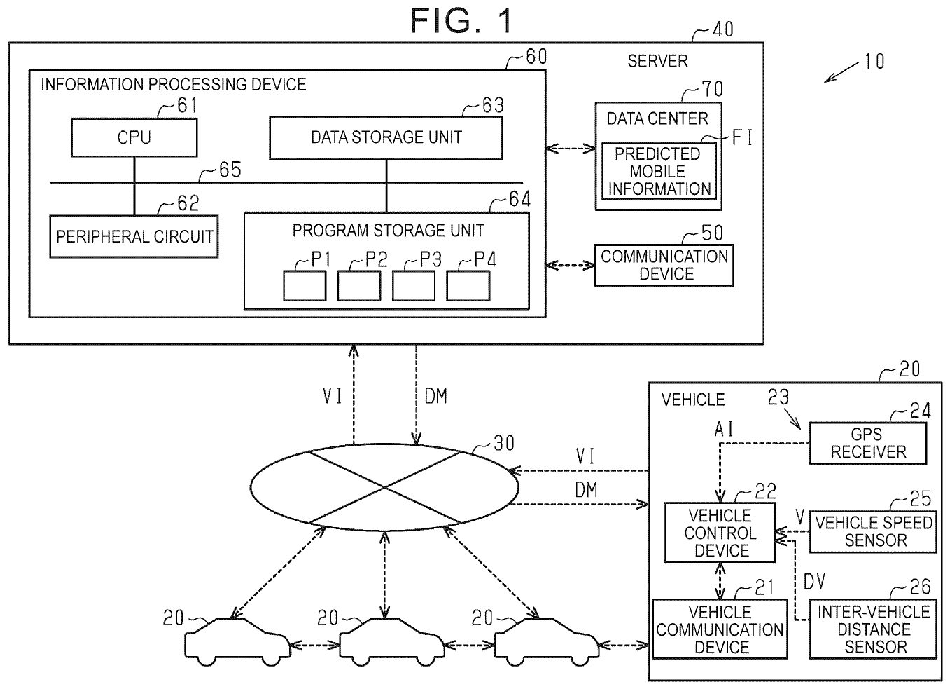

An outline of the communication system will be described. As illustrated in FIG. 1, the communication system 10 includes a plurality of vehicles 20, a wireless communication network 30, and a server 40.

The vehicle 20 includes a vehicle communication device 21, a vehicle control device 22, and a plurality of information acquisition devices 23. The vehicle communication device 21 communicates with the server 40 through wireless communication via the wireless communication network 30. In addition, the vehicle communication device 21 communicates with another vehicle 20 by vehicle-to-vehicle communication. The vehicle control device 22 controls communication of the vehicle communication device 21.

The plurality of information acquisition devices 23 acquire various types of information of the vehicle 20. The plurality of information acquisition devices 23 are a GPS receiving device 24, a vehicle speed sensor 25, and an inter-vehicle distance sensor 26. GPS receiving device 24 receives, from GPS device, absolute position information AI indicating the absolute position of the vehicles 20. The absolute position is a position indicated by coordinate values of latitude and longitude. Therefore, the absolute position information AI includes latitude and longitude information. The vehicle speed sensor 25 acquires the traveling speed of the vehicle 20 as the vehicle speed V. The inter-vehicle distance sensor 26 detects an inter-vehicle distance DV which is a distance from the vehicle 20 to the vehicle 20 traveling ahead of the vehicle 20. An exemplary inter-vehicle distance sensor 26 is Laser Imaging Detection and Ranging (LIDAR). Each information acquisition device 23 outputs the acquired information of the vehicle 20 to the vehicle control device 22.

The vehicle control device 22 controls the following travel of the vehicle 20. The vehicle control device 22 controls, by the user's operation, the following travel that follows the other vehicle 20 traveling ahead of the vehicle 20. When the vehicle 20 travels following the preceding vehicle, the vehicle 20 and the preceding vehicle are in a state of traveling in a following relationship. The vehicle control device 22 generates a follow-up information FD indicating that the vehicle is in follow-up travel when the vehicle is in follow-up travel. The vehicle control device 22 includes a storage unit. The storage unit of the vehicle control device 22 includes counters for counting the number NM of following vehicles RV, which will be described later. The storage unit of the vehicle control device 22 can temporarily store information.

The vehicle control device 22 acquires various kinds of information of the vehicle 20 acquired from the plurality of information acquisition devices 23, the time at which the various kinds of information are acquired, and the follow-up information FD of the vehicle 20 as the moving object information VI. The moving object information VI is information of the real-world vehicles 20.

The vehicle control device 22 outputs the moving object information VI to the vehicle communication device 21. Then, the vehicle communication device 21 transmits the mobile moving object information VI to the server 40. In FIG. 1, one vehicle 20 of the plurality of vehicles 20 is illustrated in detail, and the other vehicle 20 is illustrated in detail without detail. The vehicles 20 transmit the moving object information VI to the server 40.

The server 40 is capable of communicating with a plurality of vehicles 20. The server 40 acquires the plurality of moving object information VI from the plurality of vehicles 20. The server 40 can transmit various types of request DM based on the predicted moving object information FI generated based on the moving object information VI, which will be described later, to the vehicles 20. The server 40 includes a communication device 50, an information processing device 60, and a data center 70.

The communication device 50 communicates with a plurality of vehicles 20. The communication device 50 receives the moving object information VI transmitted from the vehicles 20. The communication device 50 outputs the received moving object information VI to the information processing device 60. Further, the communication device 50 transmits the information acquired from the information processing device 60 to the vehicle 20.

The information processing device 60 includes a CPU 61 as an executing device, peripheral circuit 62, a data storage unit 63, a program storage unit 64, and a bus 65. The bus 65 communicatively connects CPU 61, the peripheral circuit 62, the data storage unit 63, and the program storage unit 64 to each other. The peripheral circuit 62 includes a circuit that generates a clock signal that defines an internal operation, a power supply circuit, a reset circuit, and the like. The data storage unit 63 stores data generated in association with the operation of CPU 61. The program storage unit 64 stores a generation program P1 of the predicted moving object information FI, a determination program P2 of the group GR, a request program P3 of transmitting the position information, and a process program P4 of the inter-vehicle distance information DI. CPU 61 performs information processing by executing various programs stored in the program storage unit 64.

The data center 70 stores the predicted moving object information FI. The predicted moving object information FI is information including a plurality of moving object information VI generated based on the moving object information VI of the plurality of vehicles 20 and after the time when the moving object information VI in the predetermined area is acquired. The predetermined area may be, for example, a range including one country, a range including only some regions of one country, or a range including the entire world. That is, the predicted moving object information FI is a so-called digital twin. In addition, the data center 70 stores time-series data of the predicted moving object information FI generated by the information processing device 60. The data center 70 acquires the predicted moving object information FI generated by the information processing device 60 a plurality of times over time. As a result, the data center 70 stores the time-series data of the predicted moving object information FI.

### Generation of Predicted Mobile Information

CPU 61 repeatedly generates the predicted moving object information FI by repeatedly executing the generation program PI of the predicted moving object information FI at a predetermined cycle. The predetermined period is defined as, for example, one minute.

When CPU 61 starts executing the program PI for generating the predicted moving object information FI, it first acquires the moving object information VI of the vehicles 20 in the communication system 10. Next, CPU 61 generates the predicted moving object information FI based on the acquired moving object information VI. First, CPU 61 refers to information indicating the acquired time for the plurality of acquired moving object information VI. Next, CPU 61 predicts the moving object information VI at the reference time by correcting the other moving object information VI by the difference of the times using the time of the moving object information VI having the newest acquired time as the reference time. For example, CPU 61 is predicted by correcting based on the moving object information VI such as the previous vehicle speed V. Then, CPU 61 generates various kinds of information of the predicted moving object information VI as the predicted moving object information FI. As a result, CPU 61 acquires the moving object information VI of the plurality of vehicles 20 synchronized with the reference time as the predicted moving object information FI. Thereafter, CPU 61 stores the acquired predicted moving object information FI in the data center 70. In this manner, the information processing device 60 generates the predicted moving object information FI.

### Determining Whether a Group is Configured

CPU 61 repeatedly executes the determination program P2 of the group GR traveling in the following relationship at a predetermined cycle. The predetermined period is defined as, for example, one minute. Thus, CPU 61 determines the vehicle 20 constituting the group GR, that is, the vehicle 20 traveling in the following relationship, and the vehicle 20 not constituting the group GR, that is, the vehicle 20 not traveling in the following relationship, among the plurality of vehicles 20 in the predetermined arca.

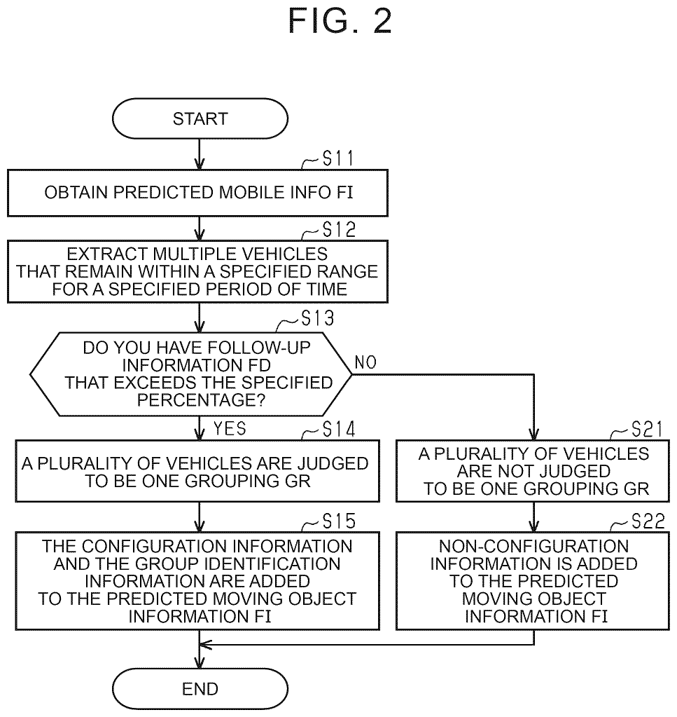

As shown in FIG. 2, when CPU 61 starts executing P2 of the determination program of the group GR, it starts S11 process. In S11, CPU 61 acquires data of the time-series data of the predicted moving object information FI in the data center 70 for a predetermined time period. The past predetermined period is, for example, 3 minutes. Thereafter, CPU 61 advances the process to S12.

In S12, CPU 61 extracts a plurality of vehicles 20 that continue to exist within a predetermined range for a predetermined period in the past, based on the time-series data of the predicted moving object information FI acquired by S11 for a predetermined period in the past. The specified range is, for example, a range in which the distance between the plurality of vehicles 20 is within 100 meters. Thereafter, CPU 61 advances the process to S13. In S12, when CPU 61 cannot extract the plurality of vehicles 20, CPU 61 adds non-configuration information indicating that the grouping GR is not configured to the predicted moving object information FI for all the vehicles 20, and ends the series of processes.

In S13, CPU 61 determines whether or not the number of vehicles 20 having a specified ratio or more among the plurality of vehicles 20 extracted by S12 is following. The specified ratio is, for example, 50%. Specifically, CPU 61 determines whether or not the follow-up information FD is included in the moving object information VI of the plurality of vehicles 20 extracted by S12. Then, CPU 61 compares the number of moving object information VI including the follow-up information FD with the number extracted by S12.

When the follow-up information FD is equal to or larger than the specified ratio (S13: YES), CPU 61 advances the process to S14. In S14, CPU 61 determines the plurality of vehicles 20 extracted by S12 as a group GR traveling in one group. Thereafter, CPU 61 advances the process to S15.

In S15, CPU 61 adds configuration information indicating that the group GR is configured and group identification information identifying the configured group GR to the predicted moving object information FI for the plurality of vehicles 20 determined to be one group GR in S14. Thereafter, CPU 61 ends the series of processes.

On the other hand, when the follow-up information FD is not equal to or larger than the specified ratio (S13: YES), CPU 61 advances the process to S21. In S21, CPU 61 does not determine the plurality of vehicles 20 extracted by S12 as one grouping GR. Thereafter, CPU 61 advances the process to S22.

In S22, CPU 61 adds, to the predicted moving object information FI, non-configuration information indicating that the group GR is not configured for the plurality of vehicles 20 that have not been determined to be one group GR in S21. Thereafter, CPU 61 ends the series of processes. In this way, the group GR determination program P2 is executed so that the predicted moving object information FI includes information indicating whether or not the group GR is configured.

### Request from the Server to the Vehicle

Next, the request DM for the vehicles 20 constituting the grouping GR performed by the information processing device 60 will be described. CPU 61 repeatedly executes the request program P3 for transmitting the position data at a predetermined cycle. CPU 61 repeatedly executes the process for cach grouping GR composed of a plurality of vehicles 20. Therefore, CPU 61 refers to the predicted moving object information FI to determine a target for executing the request program P3, and then starts executing the request program P3 for cach grouping GR.

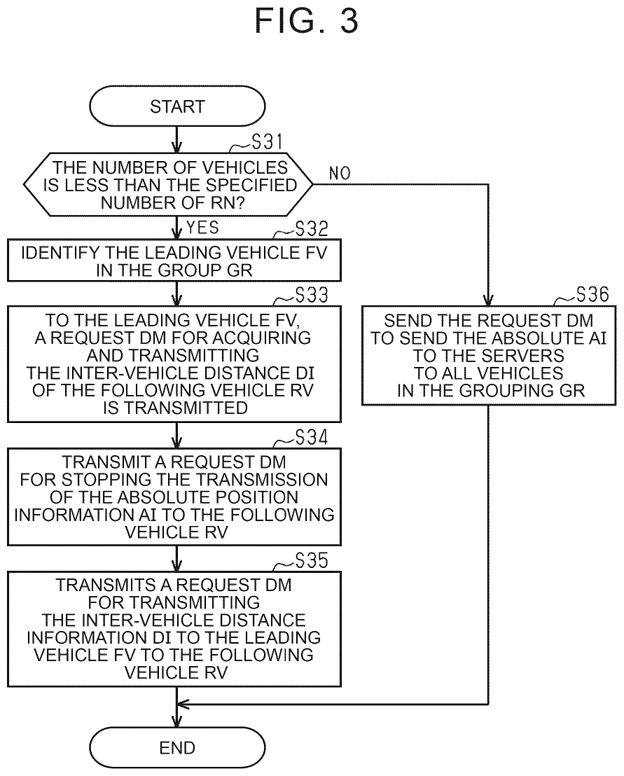

As shown in FIG. 3, when CPU 61 starts executing the request program P3, it first executes S31 process. In S31, CPU 61 determines whether or not the number of vehicles 20 constituting the grouping GR is less than a predetermined specified number RN. The specified number RN is, for example, 10. When the number of vehicles 20 constituting the grouping GR is less than the specified number RN (S31: YES), CPU 61 advances the process to S32.

In S32, CPU 61 identifies the leading vehicle FV of the grouping GR based on the predicted moving object information FI. For example, CPU 61 refers to the absolute position of the vehicle 20 in the predicted moving object information FI, and estimates a column formed by the plurality of vehicles 20. Next, CPU 61 refers to the predicted moving object information FI and estimates the direction in which the column moves. Then, CPU 61 estimates that, among the vehicles 20 at both ends of the estimated column, the vehicle 20 at the end of the estimated moving direction is the leading vehicle FV. Thereafter, CPU 61 advances the process to S33.

In S33, CPU 61 transmits, to the leading vehicle FV, a request DM for acquiring the inter-vehicle distance information DI of the following vehicle RV that is the vehicle 20 excluding the leading vehicle FV among the vehicles 20 constituting the group GR and transmitting the inter-vehicle distance information to the server 40. The inter-vehicle distance DV of the following vehicle RV is an inter-vehicle distance DV between the following vehicle RV and a preceding vehicle traveling ahead of the following vehicle RV. Thereafter, CPU 61 advances the process to S34.

In S34, CPU 61 sends a request DM to the following vehicle RV to cease sending the absolute position information AI to the server 40. Thereafter, CPU 61 advances the process to S35.

In S35, CPU 61 transmits a request DM for transmitting the inter-vehicle distance information DI to the leading vehicle FV to the following vehicle RV. As a result, CPU 61 ends the series of processes.

On the other hand, when the number of vehicles 20 constituting the grouping GR is equal to or greater than the specified number RN (S31: NO), CPU 61 advances the process to S36. In S35, CPU 61 transmits a request DM for stopping the transmission of the inter-vehicle distance information DI and transmitting the absolute position information AI to the server 40 to all the vehicles 20 constituting the grouping GR. As a result, CPU 61 ends the series of processes. When the non-configuration information is added to the predicted moving object information FI, CPU 61 performs the same process as that of S36.

### Information Transmission of the Following Vehicle

Next, a process performed by the vehicle control device 22 of the following vehicle RV that has received the request DM from the server 40 by the processes of S34 and S35 will be described. In the following, the vehicle control device 22 of the following vehicle RV will be described as a vehicle control device 22R. Upon receiving the request DM from the server 40, the vehicle control device 22R performs control to transmit the inter-vehicle distance information DI to the leading vehicle FV.

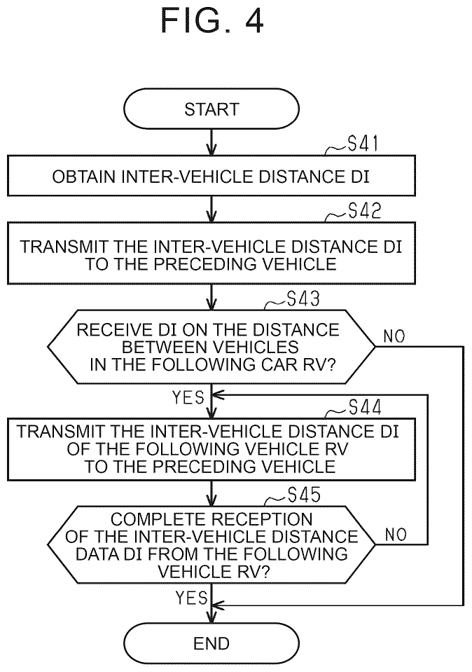

As illustrated in FIG. 4, when the transmitting control is started, the vehicle control device 22R first performs a S41 process. In S41, the vehicle control device 22R acquires information indicating the inter-vehicle distance DV detected by the inter-vehicle distance sensor 26 as the inter-vehicle distance information DI of the host vehicle. The inter-vehicle distance DV of the host vehicle is an inter-vehicle distance DV between the host vehicle and a preceding vehicle traveling ahead of the host vehicle. Thereafter, the vehicle control device 22R advances the process to S42.

In S42, the vehicle control device 22R transmits the inter-vehicle distance information DI of the host vehicle to the preceding vehicle. Thereafter, the vehicle control device 22R advances the process to S43.

In S43, the vehicle control device 22R determines whether or not the inter-vehicle distance information DI of the following vehicle RV is received from the following vehicle RV having the host vehicle as the preceding vehicle. Specifically, the vehicle control device 22R determines whether or not the inter-vehicle distance information DI of the following vehicle RV has been received from the following vehicle RV prior to the clapse of a predetermined period after S43 process is started. The vehicle control device 22R ends this series of processes when the vehicle control device 22R does not receive the inter-vehicle distance information DI of the following vehicle RV from the following vehicle RV (S43: NO).

On the other hand, when the vehicle control device 22R receives the inter-vehicle distance information DI from the following vehicle RV (S43: YES), the vehicle control device 22R advances the process to S44. In S44, the vehicle control device 22R transmits the acquired inter-vehicle distance information DI of the following vehicle RV to the preceding vehicle. That is, the vehicle control device 22R forwards the inter-vehicle distance information DI from the vehicle 20 following the host vehicle to the vehicle 20 preceding the host vehicle. Thereafter, the vehicle control device 22R advances the process to S45.

In S45, the vehicle control device 22R determines whether the reception of the inter-vehicle distance information DI from the following vehicle RV has been completed. Specifically, the vehicle control device 22R determines whether or not the inter-vehicle distance information DI of the following vehicle RV is received again from the following vehicle RV after starting the process of S45 until a predetermined period elapses. When the vehicle control device 22R does not receive the inter-vehicle distance information DI of the following vehicle RV from the following vehicle RV, it is determined that the reception of the inter-vehicle distance information DI has been completed from the following vehicle RV. On the other hand, when the vehicle control device 22R receives the following vehicle RV inter-vehicle distance information DI, it is determined that the reception of the inter-vehicle distance information DI from the following vehicle RV has not been completed. When the reception of the inter-vehicle distance information DI from the following vehicle RV has not been completed (S45: NO), the vehicle control device 22R returns the process to S44. Then, the vehicle control device 22R transmits the received inter-vehicle distance information DI to the preceding vehicle again. When the reception of the inter-vehicle distance information DI from the following vehicle RV is completed (S45: YES), the vehicle control device 22R ends the series of processes at this time.

### Information Transmission of the Leading Vehicle

Next, a process performed by the vehicle control device 22 of the leading vehicle FV that has received the request DM from the server 40 by S33 process will be described. In the following, the vehicle control device 22 on the leading vehicle FV will be described as a vehicle control device 22F. Upon receiving the request DM from the server 40 to the leading vehicle FV, the vehicle control device 22F controls the following vehicle RV to transmit the inter-vehicle distance information DI to the server 40.

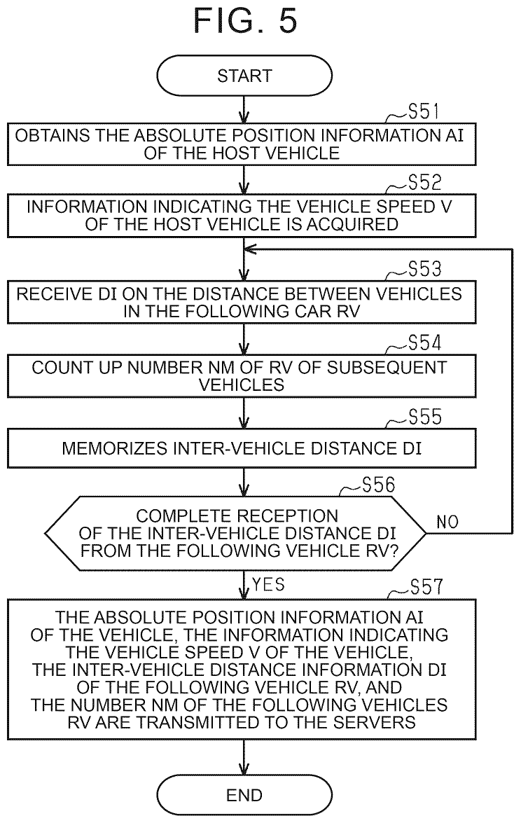

As illustrated in FIG. 5, when the transmitting control is started, the vehicle control device 22F first performs a S51 process. In S51 process, the vehicle control device 22F acquires the absolute position information AI from GPS reception device 24. Thereafter, the vehicle control device 22F advances the process to S52.

In S52, the vehicle control device 22F acquires information indicating the vehicle speed V from the vehicle speed sensor 25. Thereafter, the vehicle control device 22F advances the process to S53.

In S53, the vehicle control device 22F acquires the inter-vehicle distance information DI of the following vehicle RV from the following vehicle RV. Thereafter, the vehicle control device 22F advances the process to S54.

In S54, the vehicle control device 22F counts up counters of the number NM of following vehicles RV. Thereafter, the vehicle control device 22F advances the process to S55.

In S55, the vehicle control device 22F stores the inter-vehicle distance information DI. Thereafter, the vehicle control device 22F advances the process to S56.

In S56, the vehicle control device 22F determines whether the reception of the inter-vehicle distance information DI of the following vehicle RV from the following vehicle RV has been completed. Specifically, S56 process is the same process as S45 process. When the reception of the inter-vehicle distance information DI from the following vehicle RV has not been completed (S56: NO), the vehicle control device 22F returns the process to S54. On the other hand, when the reception of the inter-vehicle distance information DI from the following vehicle RV is completed (S56: YES), the vehicle control device 22F advances the process to S57.

In S57, the vehicle control device 22F transmits, to the server 40, the absolute position information AI of the host vehicle, the information indicating the vehicle speed V of the host vehicle, the stored inter-vehicle distance information DI of the following vehicle RV, and the information indicating the number NM of the following vehicles RV. The vehicle control device 22F clears the counters of the number NM of the following vehicles RV, and then ends the series of processes.

As shown in FIG. 1, the inter-vehicle distance information DI is received by CPU 61, and P4 of the inter-vehicle distance information is started to execute. First, CPU 61 checks whether or not the required number of inter-vehicle distance information DI have been acquired when P4 for programming the inter-vehicle distance information DI is started. Specifically, CPU 61 compares the received number NM of the following vehicles RV with the number one less than the number of vehicles 20 constituting the grouping GR. When CPU 61 does not match the numbers of the two, CPU 61 performs the same process as S36.

When CPU 61 is able to acquire the required numbers of inter-vehicle distance information DI, CPU 61 calculates the absolute position of the following vehicle RV based on the absolute position information AI of the leading vehicle FV and the inter-vehicle distance information DI of the following vehicle RV. Specifically, CPU 61 calculates, based on the absolute position indicated by the absolute position information AI of the leading vehicle FV, the position behind the inter-vehicle distance DV indicated by the inter-vehicle distance information DI as the coordinate value of the absolute position of the following vehicle RV, that is, the latitude and longitude at which the following vehicle RV is located. When the inter-vehicle distance information DI of the plurality of following vehicle RV is acquired, CPU 61 calculates the absolute position in order from the leading vehicle FV. Specifically, CPU 61 calculates the absolute position of the third following vehicle RV from the head with reference to the absolute position of the second following vehicle RV from the head as the position behind by the inter-vehicle distance DV indicated by the inter-vehicle distance information DI of the third following vehicle RV. When the absolute positions of all the vehicles 20 constituting the grouping GR are calculated, CPU 61 finishes executing the process program P4 of the inter-vehicle distance information DI.

When generating the predicted moving object information FI, CPU 61 uses, as the moving object information VI, the absolute position of the following vehicle RV calculated by executing the process program P4 of the inter-vehicle distance information DI. CPU 61 generates the predicted moving object information FI by using the calculated absolute position of the following vehicle RV for the following vehicle RV for which the absolute position information Al has not been acquired.

### Operations of Embodiment

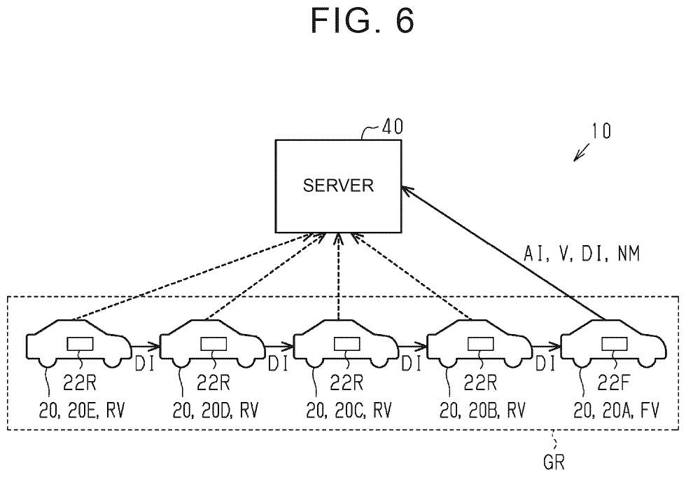

As shown in FIG. 6, it is assumed that five vehicles 20 are traveling in a group GR. The first vehicle 20A, the second vehicle 20B, the third vehicle 20C, the fourth vehicle 20D, and the fifth vehicle 20E are sequentially referred to from the first vehicle 20. In this case, the first vehicle 20A is the leading vehicle FV, and the fifth vehicle 20E from the second vehicle 20B is the following vehicle RV.

Since the number of vehicles 20 constituting the grouping GR is less than the specified number RN, the server 40 processes S34 from S32. Accordingly, the first vehicle 20A starts executing the series of processes illustrated in FIG. 5, and the fifth vehicle 20E starts executing the series of processes illustrated in FIG. 4 from the second vehicle 20B.

Accordingly, the fifth vehicle 20E transmits the inter-vehicle distance information DI of the fifth vehicle 20E to the fourth vehicle 20D that is the preceding vehicle. The fourth vehicle 20D sequentially transmits, to the third vehicle 20C, which is the preceding vehicle, the inter-vehicle distance information DI of the fourth vehicle 20D and the inter-vehicle distance information DI of the fifth vehicle 20E to the third vehicle. The third vehicle 20C sequentially transmits the inter-vehicle distance information DI of the third vehicle 20C, the inter-vehicle distance information DI of the fourth vehicle 20D, and the inter-vehicle distance information DI of the fifth vehicle 20E to the second vehicle 20B that is the preceding vehicle. The second vehicle 20B sequentially transmits, to the first vehicle 20A that is the preceding vehicle, the inter-vehicle distance information DI of the second vehicle 20B, the inter-vehicle distance information DI of the third vehicle 20C, the inter-vehicle distance information DI of the fourth vehicle 20D, and the inter-vehicle distance information DI of the fourth vehicle 20D.

On the other hand, the fifth vehicle 20E does not transmit information indicating the absolute position information AI of the host vehicle and the vehicle speed V of the host vehicle to the server 40 from the second vehicle 20B that is the following vehicle RV. Therefore, the second vehicle 20B does not transmit the absolute position information AI of the second vehicle 20B to the server 40.

The first vehicle 20A transmits the absolute position information AI of the first vehicle 20A to the server 40. The first vehicle 20A transmits the inter-vehicle distance information DI of the fifth vehicle 20E from the second vehicle 20B to the server 40. The first vehicle 20A transmits information indicating the vehicle speed V of the first vehicle 20A to the server 40. The first vehicle 20A transmits, to the server 40, information indicating that the number NM of the counted following vehicles RV is four.

Then, the server 40 receives the absolute position information AI of the first vehicle 20A, the information indicating the vehicle speed V of the first vehicle 20A, the inter-vehicle distance information DI of the fifth vehicle 20E from the second vehicle 20B, and the information indicating the number NM of the following vehicles RV. Thereafter, the server 40 calculates the absolute position of the fifth vehicle 20E from the second vehicle 20B based on the absolute position information AI of the first vehicle 20A and the inter-vehicle distance information DI of the fifth vehicle 20E from the second vehicle 20B. Further, the server 40 estimates the vehicle speed V of the fifth vehicle 20E from the second vehicle 20B as the vehicle speed V of the first vehicle 20A.

Thereafter, the server 40 generates the predicted moving object information FI using the acquired absolute value of the first vehicle 20A, the vehicle speed V of the first vehicle 20A, and the calculated absolute position of the fifth vehicle 20E from the second vehicle 20B and the vehicle speed V of the fifth vehicle 20E from the second vehicle 20B.

### Effects of Embodiment

(1) According to the above embodiment, the first vehicle 20A transmits the absolute position information AI of the first vehicle 20A and the inter-vehicle distance information DI of the second vehicle 20B to the server 40. The second vehicle 20B does not transmit the absolute position information AI of the second vehicle 20B to the server 40. Then, the server 40 calculates the absolute position of the second vehicle 20B based on the absolute position information AI of the first vehicle 20A and the inter-vehicle distance information DI of the second vehicle 20B. Therefore, the quantity received by the server 40 is smaller than the quantity received when the absolute position information AI of the second vehicle 20B is received. Therefore, the communication system 10 can prevent the amount of information received by the server 40 from being excessively large.

(2) According to the above-described embodiment, the first vehicle 20A transmits information indicating the vehicle speed V of the first vehicle 20A to the server 40. The second vehicle 20B transmits information indicating the vehicle speed V of the second vehicle 20B to the server 40. Then, the server 40 estimates the vehicle speed V of the second vehicle 20B as the vehicle speed V indicated by the information indicating the vehicle speed V of the first vehicle 20A. Accordingly, the server 40 does not need to receive the vehicle speed V of the following vehicle RV from the following vehicle RV.

(3) According to the above-described embodiment, the server 40 generates the predicted moving object information FI based on the absolute positions of the plurality of vehicles 20. The server 40 determines whether or not the second vehicle 20B is traveling in follow-up relation with the first vehicle 20A based on the predicted moving object information FI. Then, the server 40 transmits, to the second vehicle 20B, when the second vehicle 20B is traveling in the following relation with the first vehicle 20A, a request DM for stopping transmitting the absolute position information AI of the second vehicle 20B. Therefore, the server 40 can generate the predicted moving object information FI and transmit the request DM based on the predicted moving object information FI while suppressing the quantity of information to be received.

(4) According to the above-described embodiment, the second vehicle 20B transmits the second vehicle 20B absolute position information AI to the server 40 when the second vehicle 20B is not traveling in the following relation with the first vehicle 20A. Therefore, the server 40 can prevent the absolute position of the second vehicle 20B from being unavailable when the second vehicle 20B does not follow the first vehicle 20A.

(5) When the first vehicle 20A transmits the inter-vehicle distance information DI of an excessively large number of vehicles 20 to the server 40, it takes an excessively long time for the server 40 to receive the inter-vehicle distance information DI after the inter-vehicle distance information DI is acquired by the respective vehicles 20. In this regard, according to the above-described embodiment, when the vehicles 20 having the specified number of RN or more follow, the following vehicle RV does not transmit the inter-vehicle distance information DI to the server 40, and the vehicles 20 transmit the absolute position information AI to the server 40. Therefore, it is possible to prevent the absolute position of the vehicle 20 calculated by the server 40 from becoming excessively old information.

### Other Embodiments

The present embodiment can be realized with the following modifications. The present embodiment and the following modifications can be combined with each other within a technically consistent range to be realized.
When the number NM of the following vehicles RV is equal to or greater than the specified number RN, the server 40 may not transmit the following vehicle RV inter-vehicle distance information DI not to be acquired to the leading vehicle FV as the request DM. The server 40 does not have to transmit, to the following vehicle RV when the number NM of the following vehicles RV is equal to or greater than the specified number RN, the request DM for transmitting the absolute position information AI.
The server 40 does not have generated the predicted moving object information FI. The server 40 does not have to use the absolute position of the vehicles 20 to generate the predicted moving object information FI. The server 40 does not have to determine whether the second vehicle 20B is following the first vehicle 20A based on the predicted moving object information FI. For example, the server 40 may determine the following relation based on the follow-up information FD without determining the configuration of the grouping GR.
The second vehicle 20B may be a vehicle 20 that constantly follows the first vehicle 20A. In this case, the second vehicle 20B does not have to transmit the second vehicle 20B absolute position information AI to the server 40 because the second vehicle 20B does not travel without following the first vehicle 20A. That is, the plurality of vehicles 20 may not be able to travel in the following relationship.
The plurality of vehicles 20 may stop transmitting the absolute position information AI and transmit the inter-vehicle distance information DI to the preceding vehicle regardless of the request DM from the server 40.
The following vehicle RV may transmit the information indicating the vehicle speed V to the server 40 or may transmit the information to the leading vehicle FV. In place of the inter-vehicle distance DV with the preceding vehicle, the following vehicle RV may transmit the inter-vehicle distance DV with the leading vehicle FV as the inter-vehicle distance information DI.
In the above embodiment, the leading vehicle FV transmits the inter-vehicle distance information DI of the following vehicle RV to the server 40. However, among the vehicles 20 constituting the grouping GR, the vehicles 20 that transmit the inter-vehicle distance information DI of the other vehicles 20 to the server 40 are not limited to the leading vehicle FV. For example, the last vehicle 20 of the vehicles 20 constituting the grouping GR may transmit the inter-vehicle distance information DI of the other vehicles 20 to the server 40. In this case, the other vehicle 20 may deliver the inter-vehicle distance DV with the vehicle 20 traveling behind the host vehicle as the inter-vehicle distance information DI of the vehicle 20 to the vehicle 20 at the last end. That is, the following relationship may be a case where the second vehicle follows the first vehicle, or a case where the first vehicle follows the second vehicle. Further, for example, among the vehicles 20 constituting the grouping GR, a particular vehicle 20 may transmit the inter-vehicle distance information DI of another vehicle 20 to the server 40. In this case, the other vehicle 20 may transmit the inter-vehicle distance from the vehicle 20 closer to the specific vehicle 20 among the front or rear vehicles 20 traveling side by side to the specific vehicle 20 as the inter-vehicle distance information DI of the vehicle 20.

What is claimed is:

1. A communication system comprising:
a plurality of vehicles including a first vehicle and a second vehicle; and
a server capable of communicating with the vehicles, wherein when the second vehicle is traveling in a following relationship with the first vehicle,
the first vehicle
acquires absolute position information of the first vehicle including coordinate values of latitude and longitude at which the first vehicle is located,
acquires inter-vehicle distance information of the second vehicle indicating an inter-vehicle distance that is a distance between the first vehicle and the second vehicle, and
transmits the absolute position information of the first vehicle and the inter-vehicle distance information of the second vehicle to the server,
the second vehicle does not transmit absolute position information of the second vehicle including coordinate values of latitude and longitude at which the second vehicle is located to the server, and
the server calculates the coordinate values of the latitude and the longitude at which the second vehicle is located, based on the absolute position information of the first vehicle and the inter-vehicle distance information of the second vehicle.

2. The communication system according to claim 1, wherein when the second vehicle is traveling in the following relationship with the first vehicle,
the first vehicle transmits information indicating a vehicle speed of the first vehicle to the server,
the second vehicle does not transmit information indicating a vehicle speed of the second vehicle to the server, and
the server estimates the vehicle speed of the second vehicle as a vehicle speed indicated by the information indicating the vehicle speed of the first vehicle.

3. The communication system according to claim 1, wherein the server is configured to:
generate predicted moving body information based on the coordinate values of the latitude and the longitude at which the first vehicle is located and the coordinate values of the latitude and the longitude at which the second vehicle is located;
determine whether the second vehicle is traveling in the following relationship with the first vehicle based on the predicted moving body information; and
when the second vehicle is traveling in the following relationship with the first vehicle, transmit a request to stop transmission of the absolute position information of the second vehicle to the second vehicle.

4. The communication system according to claim 1, wherein when the second vehicle is not traveling in the following relationship with the first vehicle, the second vehicle transmits the absolute position information of the second vehicle to the server.

5. The communication system according to claim 1, wherein when a specified number of vehicles or more, including the second vehicle, are traveling following the first vehicle as succeeding vehicles led by the first vehicle, the server transmits a request to transmit absolute position information of the succeeding vehicles including coordinate values of latitude and longitude at which the succeeding vehicles are located to the succeeding vehicles.
